(19) United States
(12) Patent Application Publication
(10) Pub. No.: US 2010/0306324 A1
(43) Pub. Date: Dec. 2, 2010

(54) ANONYMOUSLY AND AUTONOMOUSLY BRIDGING RETURN SYSTEM AND METHOD

(76) Inventors: Allan J. Bontempo, New York, NY (US); Bryan D. Davis, New York, NY (US)

Correspondence Address: DUANE MORRIS LLP - NY;PATENT DEPARTMENT, 1540 BROADWAY, NEW YORK, NY, 10036-4086, US

(21) Appl. No.: 12/476,186

(22) Filed: Jun. 1, 2009

(51) Int. Cl. G06F 15/16

(52) U.S. Cl. 709/206

(57) ABSTRACT

A method and arrangement to facilitate a direct, anonymous communication between an owner and a finder regarding an article.

### FIELD OF THE INVENTION

Aspects of the invention relate to systems and methods for enabling the finder of a lost entity (whether an inanimate article or being) to contact and open communication with the party responsible for that entity (i.e. the owner) while maintaining the responsible party's anonymity (until and if the owner acts to end that anonymity). Various embodiments also provide for the responsible party to mark an article. The non-limiting embodiments of the systems and methods according to the present invention primarily involve communication via SMS (short message service) text messages or other electronic messages routed through an automatically actuating clearinghouse that can provide a variety of functions including a core function of receiving a finder's message that is routed to the appropriate responsible party (owner) so that the responsible party can exchange messages with the finder via the clearinghouse while preserving the anonymity of the owner. E-mail messaging is also supported as a supplementary communication pathway. The entity is prepared for retrieval according to the short code or long number or target address for the finder's message (such as an SMS) and a serial code or other marking that indicates the particular individual entity found.

### BACKGROUND INFORMATION

When an individual loses an item, one of four different possibilities exist. In the first possibility, the item is irretrievably lost. In the second possibility, the individual himself/herself discovers the item's whereabouts and the item is no longer lost.

In the third possibility, the item is found by a person other than the rightful owner of the item. If the person who finds the item is not familiar with the owner, the item cannot be returned. In a fourth possibility, the person finds the article and keeps it or discards it.

Returning an item to a person who lost the item is important, and in some instances, vital. For example, an item, such as keys for a luxury car, can be extremely expensive to replace. Depending on the item that is lost, individuals cannot wait for the item to be returned. In the example of luxury car keys, the car may be immobilized until the keys are returned. If the return time is two weeks, the owner may be unable to use the car for what is an unacceptably long period of time. The rightful owner of the keys would then be forced to replace the keys due to the return time involved which can be costly. In most cases, however, the finder wants to return the item to the rightful owner but cannot. There is no system or method to return an item to an owner in a confidential way that is also economically and expeditious and without the need for third parties.

One known proposed solution is to provide the item with contact information of the owner attached to it that includes a name and address. Unfortunately under that system anonymity is lost as to rightful owner of the item. Thus the case of luxury car keys, the individual finding the keys would know the identity of the person who owns the luxury car and this situation allows less then reputable people to have access to the luxury car, potentially stealing the car.

There is a need to provide a method and system that will identify/mark an item so that a finder may contact the owner that lost the item in a confidential manner.

There is a further need to provide a method and system that will return the item to the individual in a quick manner.

There is a further need to provide a method and system that will allow for return of an item in an anonymous manner, without the owner of the lost item being identified.

There is a further need to provide a method and system that will allow an article to be returned to an owner by a finder that is low cost and fully automated and will also protect the owner's anonymity.

There is a further need to provide a method and system that will allow for the bridging of an anonymous conversation between people to allow the return of an item that is convenient to both the finder and the owner. There is a still further need to provide the method and system such that the process is simple and cost effective and that can be backed up and security ensured.

There is a further need to provide a method and system that will allow for automatic response to a finder, finding the object, thereby potentially protecting the owners materials as they may be returned in a timely manner.

### SUMMARY

It is therefore an objective of an aspect of the invention to provide a method and system that will allow the owner or responsible party of an item to anonymously identify/mark said item so that a finder of said item may directly contact the owner that lost the item in order that a return of the item may be arranged. The item may also be marked at a third party location such as a manufacturer or retail store. In the event of a loss of the item, the method and system allow for a bridging of a conversation between an owner and a finder of the item.

It is a further objective of an aspect of the invention that will return the item to the owner in a quick manner.

It is still further objective of an aspect of the invention to provide a method and system that will allow for return of an item in an anonymous manner without the owner of the lost item being identified.

It is a further objective of an aspect of the invention to provide a method and system that will allow an article, to be returned to an owner by a finder that is low cost and fully automated.

It is a further objective of an aspect of the invention to provide a method and system that will allow for the bridging of an anonymous conversation between people. The conversation may allow for the return of an item that is convenient to both the finder and the owner. It is a still further objective of an aspect of the invention to provide the method and system such that the process is simple and cost effective and that can be backed up and security ensured.

The objectives of the invention are achieved as illustrated and described. In one embodiment, a method to find and retrieve a lost article is provided. This method provides entering personal information into a storage arrangement confidentially linking a marking to an owner; one of affixing a physical identification tag with the marking or affixing the marking to the article, the marking containing the text message address to the storage arrangement; activating an account in the storage arrangement on a receiving of a text message from the owner; entering a text message into a communication device linked to a storage arrangement and a wireless network upon a finding of the article by a finder; receiving the text message from the finder by the storage arrangement through the wireless network; one of decoding and cross-referencing the text message from the finder by the storage arrangement and identifying the owner that lost the article from the decoded text message; generating a found message, on the storage arrangement, based upon the text message; relaying the found message from the storage arrangement to the owner through the wireless network; receiving the found message through the wireless network by the owner; and bridging a text message conversation between the owner and the finder, wherein an owner's identity is anonymous.

In an alternative embodiment, an arrangement is provided. The arrangement provides at least one of a physical identification tag and a marking, the physical identification having a serial number and a text message address placed upon the at least one physical identification tag and marking; and a confidential computer storage arrangement, the computer storage arrangement being loaded with owner information linked to at least one owner cellular telephone and the text message address and wherein the confidential computer storage arrangement is configured to receive cellular telephone text messages at the message address specified on the at least one physical identification tag and marking.

In some embodiments, the method may be performed wherein the communication device is at least one of a telephone and a text messaging device.

In some embodiments, the text message sent to the storage arrangement is a code.

In some embodiments, the method is performed wherein the storage arrangement either decodes the text message or cross references data in the storage arrangement related to the text message.

In some non-limiting embodiments, the found message that is sent to the owner is a personalized message based upon either the decoded alpha numeric code or the cross referenced data in the storage arrangement.

In some non-limiting embodiments, the method is performed wherein the article is one of a set of car keys, a computer, an electronic device, clothing, sun glasses, golf clubs, pets, luggage and personal property.

In some non-limiting embodiments, the method is performed wherein the electronic device is one of a personal digital assistant, a digital music player, a computer and a cellular telephone. The method may also be performed wherein the code is an alpha numeric code.

In some embodiments, the method further comprises checking of the text message by the storage arrangement for authenticity after the decoding of the text message from the individual by the storage arrangement and identifying the owner that lost the article from the decoded text message.

In some embodiments, the method is performed wherein a step of verifying an authenticity of the text message after receiving the text message from the individual by the storage arrangement is accomplished.

In some non-limiting embodiments, the present invention provides a program storage device readable by machine, tangibly embodying a program of instructions executable by the machine to perform a method to find and retrieve a lost article, having steps of receiving the text message from the individual by the storage arrangement through the wireless network; one of decoding and cross-referencing the text message from the individual by the storage arrangement and identifying the owner that lost the article from the decoded text message; generating a found message, on the storage arrangement, based upon the text message; relaying the found message from the storage arrangement to the owner through the wireless network; receiving the found message through the wireless network by the owner; and facilitating a “text message” conversation between the owner and the finder, wherein an owner's identity is anonymous.

In another embodiment a method or a program storage device readable by machine, tangibly embodying a program of instructions executable by the machine to perform a method to find and retrieve a lost article, is presented. In this embodiment the method comprises entering personal information into a storage arrangement confidentially linking a marking to an owner; activating an account in the storage arrangement on a receiving of a text message from the owner; receiving the text message from the finder by the storage arrangement through the wireless network; one of decoding and cross-referencing the text message from the finder by the storage arrangement and identifying the owner that lost the article from the decoded text message; generating a found, message, on the storage arrangement, based upon the text message; relaying the found message from the storage arrangement to the owner through the wireless network; and facilitating a “text message” conversation between the owner and the finder, wherein an owner's identity is anonymous.

In another embodiment, a program storage device and a method to facilitate communication between a first person and a second person, wherein an identity of the first person remains confidential, are provided. The method accomplished comprises entering text message information into a storage arrangement confidentially linking a serial number to a first person, receiving the text message from the second person by the storage arrangement through the wireless network, identifying the first person from the text message by the storage arrangement, identifying a cellular telephone number of the finder through caller identification, generating a message, on the storage arrangement, based upon the text message and providing the cellular telephone number of the second person in the message, relaying the message from the storage arrangement to the first person through the wireless network; and bridging a text message conversation between the first person and the second person. In another embodiment, both the first and second persons may be anonymous. In some embodiments, only the first person remains anonymous. The anonymity may be lost at the discretion of the owner or first person.

### BRIEF DESCRIPTION OF THE DRAWINGS

FIG. 1 is a flow chart of a method to retrieve a lost item.

FIG. 2 is diagram of an arrangement of components to perform the method of FIG. 1.

FIG. 3 is a diagram of an example tag for placement on an item.

FIG. 4 is a diagram of a flowchart for the procedure for sent text messages.

FIG. 5 is a flowchart for a sign-up process.

FIG. 6A is a flowchart for message retrieval via text message and email.

FIG. 6B is a flowchart for message retrieval via text message and email.

### DETAILED DESCRIPTION

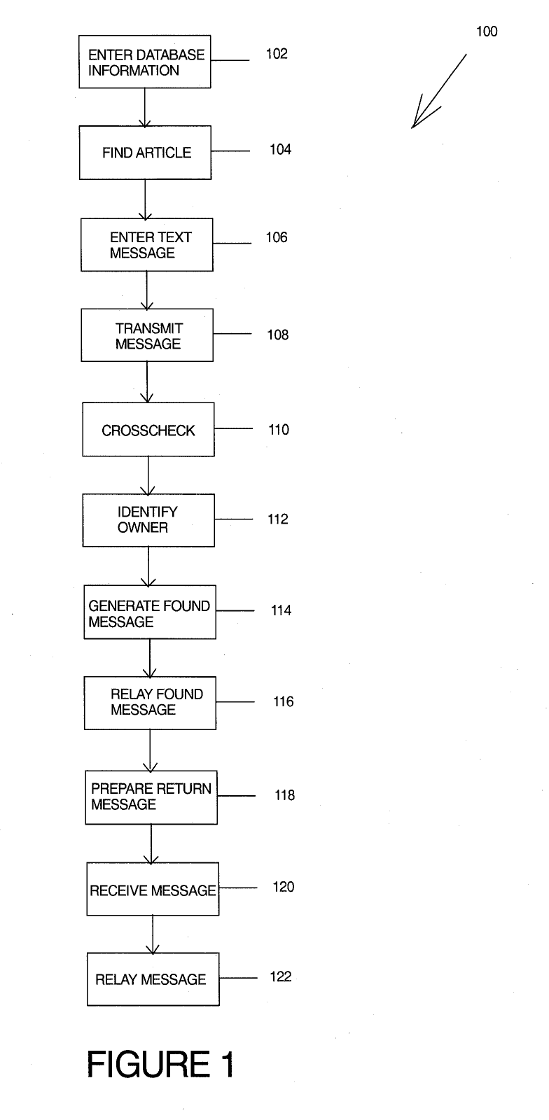

FIG. 1 illustrates a method 100 to retrieve or return a lost item. In the illustrated embodiment the item may be, for example, a set of luxury car keys. The method 100 provides for entering information into a storage arrangement thereby confidentially linking a physical identification tag 300 to an owner 102. As described in the present embodiment, all text messaging can be performed through a standard cellular telephone connected to a wireless network or any other text message device, such as a Personal Digital Assistant (PDA). Although described as a wireless network, other forms of communication, including wired communication, are applicable. Any type of applicable wireless network may be used. The information placed into the storage arrangement 202 may include, but not be limited to a user's name, email, cellular telephone address, appropriate serial number, described later, and thus the system is activated when information is successfully input into the storage arrangement 202 by the owner. This information, in the described embodiment, is conducted completely through a wireless cellular telephone network. Other input possibilities may be performed, and therefore the use of the wireless cellular telephone network should not be considered limiting. The storage arrangement 202 is described as confidential, as individuals, other than specifically designated individuals such as a system administrator, who participate within the system do not know any particular details about other individuals participating within the system 200. Thus, all data contained within the system 200 may be strictly guarded by the system administrator. The marking may be done in different ways, such as molding or through different applications of materials, therefore the illustrated embodiments are to be considered non-limiting. A first party may send a message through the aforementioned system (which may be called a “bridging system,”) which sends the message to the second party. Information about the second party may not be provided. Intended in the scope of a bridging system is a system that forwards the text of a message as written, as well as a system that receives a message from a first party, and after analysis of that message forwards a different text message, wherein the content of the message from the first party contains a code that indicates which second message should be sent. The term “bridging” as used herein refers to the relaying of a communication from a first party to a second party through a third party, apparatus or system. The third party, apparatus or system can, for example, be a live person or a central processing unit or other computer device that automatically transmits a message based on one or more of the content of the message, the re line or the addressee. In some embodiments, in the process of bridging a communication, the third party, system or apparatus can withhold identification information of one or both of the parties. Bridging may occur from a first party to a second party and back from the second party. In some embodiments, party identification of one of the parties is transmitted e.g., when the system sends a message originating with the first party, but party identification information is not transmitted in the other direction, e.g., when a response is initiated by the second party. In terms of the application, the term bridging is defined as establishing a connection between at least two individuals. The term facilitating is defined as allowing or enhancing activities between at least two individuals or organizations.

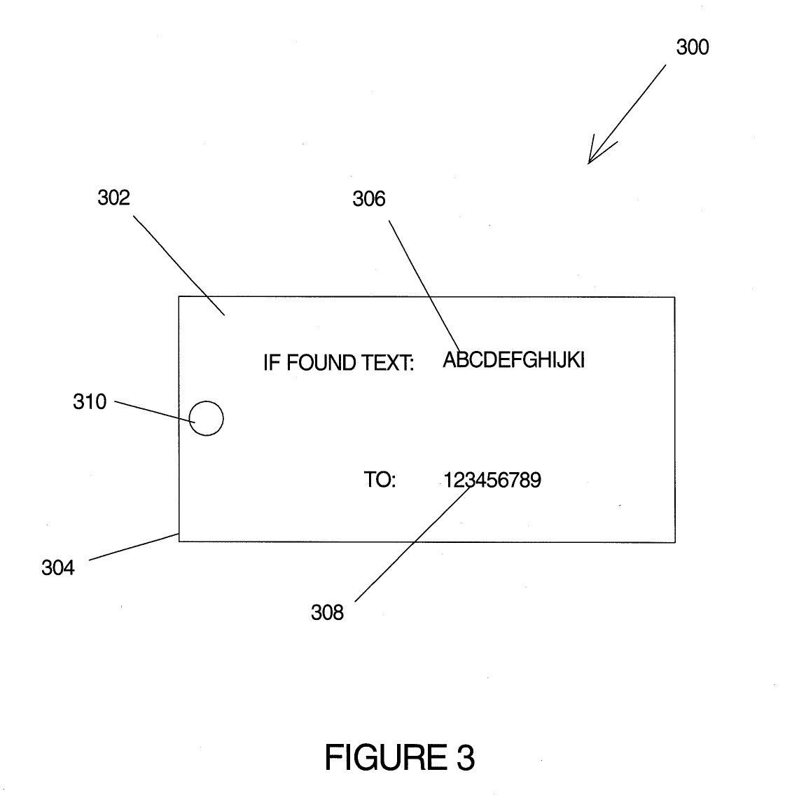

The method 100 then provides for affixing a physical identification tag 300 to the article that is desired to be protected against loss. The physical identification tag 300 is a unit that includes a serial number 306 as well as a text message address 308, described later. In the event that an individual finds the article with the physical identification tag 300, the finding individual is requested to text message the code to a predefined text message address. The tag 300 may, for example, be affixed to an owner's keys, through an attachment point to the key ring, in an example embodiment. Referring to FIG. 3, the tag 300 contains, in the example embodiment, text message information in the form of a text message address 308 and a serial number 306 that is provided to the storage arrangement 202 when an individual finds the article that is lost. In the illustrated embodiment, the tag 300 contains simple/basic instructions on how to contact the rightful owner in the event that the item becomes lost. The tag 300 contains both a text address 308 and a serial number 306. The serial number 306 is also encoded to prevent unauthorized access to information. For a text message to be successfully delivered, both the text address 308 and the serial number 306 must correspond to data placed within the storage arrangement. It is within the scope of the invention to have each owner have a different text address or for a plurality of owners to have the same text address at the server but be differentiated by the serial number or portion of the serial number.

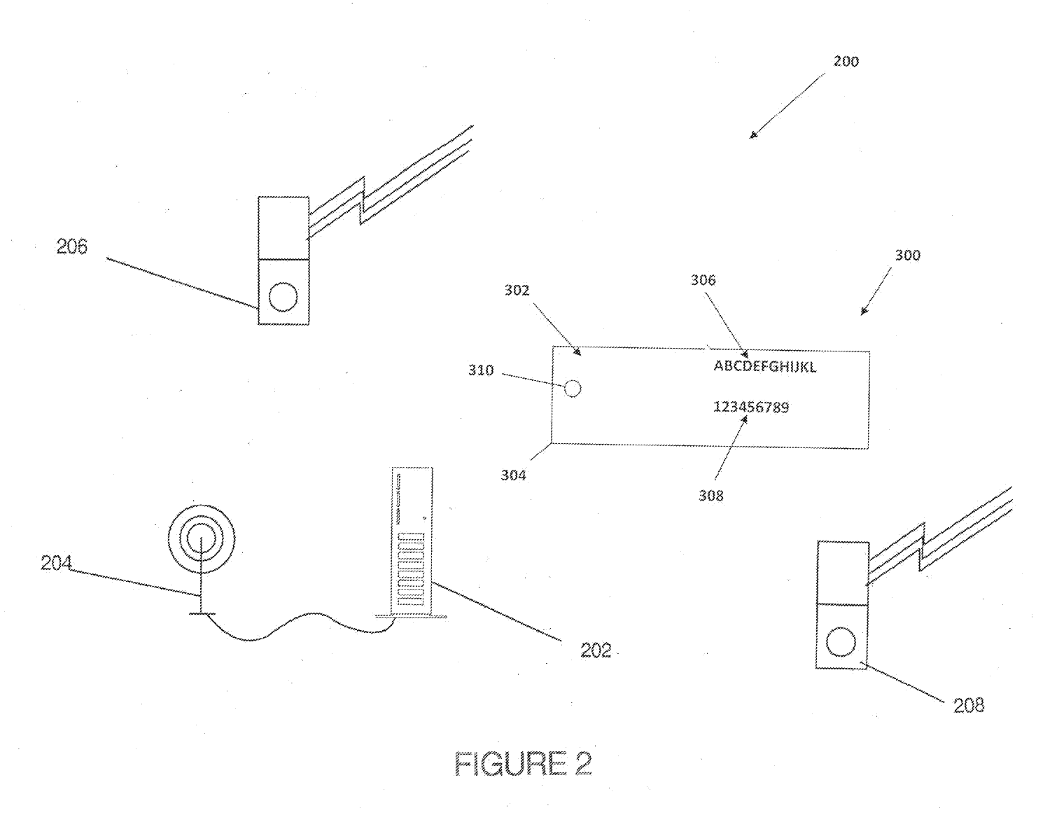

The individual that finds the article enters a text message containing the serial number into a mobile communication device linked to a wireless network. In the example embodiment, a storage arrangement is connected to the wireless network. The finder enters a text message in step 106. The mobile communication device may be, in a non-limiting example, a cellular telephone, as illustrated in FIG. 2. Next, the text message information from the finding individual is transmitted by the cellular telephone and is ultimately received by the storage arrangement 108 that is connected to the cellular telephone network.

The serial number from the individual finding the article is then crosschecked with the records previously stored in the storage arrangement 202 and the text message is decoded by the storage arrangement 110.

If the text message code and the addressee are correct in the text message provided to the storage arrangement, the owner is identified by the storage arrangement 112. Next, the method 100 provides for generating a “found” message based upon the decoded text message 114 if the addressee and the text message code correspond to known data stored within the storage arrangement 202. Then, the method 100 provides for relaying the “found” message from the storage arrangement to the owner that lost the article 116 via text message and email. In the illustrated embodiment, one message is generated for all “found” message types. In another embodiment, a customizable message is created by the owner at the time when the owner completes a sign-up procedure submitting personal information to the storage arrangement 202. All personal information may be submitted by computer input form, cell phone or through paper format. In another example embodiment, communication that is bridged between individuals is done though the system, keeping the parties anonymous. The parties may choose at a later time to communicate in a non-anonymous manner. In some embodiments, both parties must consent to the loss of anonymity. In other embodiments this power is exclusively in the control of the owner.

A “return” message is prepared from the owner that lost the article to the storage arrangement 202, the return message may contain information on how to return the article to the owner who lost the article 118 or in another example embodiment, the owner and the finder are prompted to communicate. In the illustrated embodiment, the “return” message may be a predetermined message stored within the storage arrangement 202. In an alternate configuration, the “return” message may be a customizable message that is determined by the owner of the article. The customizable message may be created by the owner at the time when the owner completes a sign-up procedure submitting personal information to the storage arrangement 202 or may be created at the time of receipt of the “found” message. In this example embodiment, this is created at the time of receipt.

The “return” message is received at the storage arrangement 120. The “return” message is relayed from the storage arrangement 202 to the individual that found the article, the return message may contain information on return options for the individual 122. Upon receipt of the “return” message, the individual finding the article may then return the found article through the information provided in the “return” message or the two parties may negotiate and communicate regarding how to return the object in the most convenient manner possible. In the illustrated embodiment, a conversation is bridged between parties.

FIG. 3 presents a example tag 300 for placement on an item. In the example embodiment, the tag 300 is provided with a front 302 and a back 304 and is a rounded rectangular shape. In the illustrated embodiment, the rounded rectangular shape is approximately 3 centimeters long by 2 centimeters high and .25 cm thick. In an example embodiment, the tag 300 is made of aluminum to minimize corrosion. Although the tag is made of aluminum in the example embodiment, other materials may be used, including but not limited to plastic and polycarbonates. In some embodiments, the article may be marked such that the identification is molded into the parts of the article. Any type of permanent marking may be performed.

In an example embodiment, the tag 300 has a text message address 308. The tag 300 also provides for a serial number 306 that is entered by the individual that finds the article with the tag 300 into a cellular phone network that will be decoded by the storage arrangement 202. In all illustrated configurations, the serial number 306 and the text message address 308 may be stamped into the tag 300 to provide permanent marking on the tag 300. The tag 300 is further provided with hole 310 to allow the tag to be attached to a key ring. In an alternative embodiment, the tag 300 may be configured with an adhesive strip or other connection mechanism to allow the tag to be affixed to the article.

The present invention allows for materials, such as keys, to be returned to their rightful owner. The system and method allow for the parties, the owner and the finder, to converse. The use of a storage arrangement allows for direct, real time anonymous communication between the individual that finds the item and the rightful owner of the article. This is a significant advance over conventional technologies that, for example, provide other “anonymous” drop boxes or concierge services, as the embodiments of the present invention allow for immediate return of the item. Aspects of the invention are also significantly better than conventional systems as at least one or both of the two parties can communicate directly with one another without sacrificing anonymity.

Various embodiments of the present invention further allow for return of the item without the need for the finding individual having to take drastic steps for return of the item. The parties may arrange that the owner may pick up property or the finder may drop off property at a place that is convenient to them.

As data is recorded by the storage arrangement 202, all incoming text messages are saved by the system 200 in order that they may be retrieved. In some instances, the text address may be correct, as compared to the internal data contained in the storage arrangement 202, but the text message is incorrect. In a non-limiting embodiment, a system administrator may review messages received from outside sources and either route a message to the rightful owner, if needed. In other embodiments, this review is automatic and according to the instructions of a computer program product.

Referring to FIG. 2, a sample configuration/system 200 of the arrangement to identify and locate lost objects/articles is presented. In the configuration 200, a storage arrangement 202 is provided with information from users and the resulting data is stored in a non-volatile memory, as a non-limiting embodiment. The storage arrangement 202 is configured to receive information from cellular telephone networks. In the illustrated embodiment, the storage arrangement 202 is configured to send and receive text messages to and from users. The storage arrangement 202 may be configured to send and receive information through an interne connection that is in turn connected to an antenna 204 that sends and receives information.. Cellular telephones 206, 208 may be used to send and receive text messages to and from the storage arrangement 202 while individuals are within the cellular telephone network. In an example embodiment, sign up for the system is done through a cellular telephone.

In an alternative configuration, a simplified method may be used. In the simplified method, the owner texts his or her serial number and email information to the storage arrangement 202. When an individual finds the article with the identification tag/marker 300, the finder initiates a report through a text message on a cellular telephone linked to a wireless network and also through email. During receipt of the text message, the system 200 uses caller identification to identify the individual who found the article. The system 200 then generates a text message to the owner that the article has been found. The owner may initiate an anonymous text conversation with the individual that found the article through the storage arrangement. A computer algorithm may be used to remove the owners identity while forwarding the text of the response message to the finder. This step protects the identity of the owner, as the owner may ascertain the telephone number of the finder, but the owner's personal information is not provided to the finder. The owner, who receives the text message that contains the finder's telephone number from the system 200, also has the option of calling the finder directly. The storage arrangement captures information using caller ID and links the data obtained to the owner for transmission of information.

In an event that the owner does not contact the finder within a predetermined time, for example 10 to 20 minutes, the system 200 will generate a text message to the finder that will prompt the finder to leave the owner a message as to where he or she has left the found objector further details on how to retrieve the object. This message, if it is provided, will be transferred by the storage arrangement to the owner via text message and email so that the item may be recovered.

In one embodiment of the invention, a serial number and/or multiple serial numbers may be linked to a single owner cell phone number. To that end, all contacts through the system 200 will be directed to a single point for an owner. The owner, however, may also configure his/her setup such that a serial number may be linked to multiple cell phone numbers. In this embodiment, when a finder creates a text message when the article is found, the storage arrangement sends out the found text message to multiple cell phone numbers so numerous contacts may be made. This embodiment is particularly useful for objects that have more than one rightful owner, or if the owner wants a secondary point of contact. It is additionally within the scope of the invention to have a plurality of owners with a plurality of items, wherein each owner has one unique code for each of his/her items.

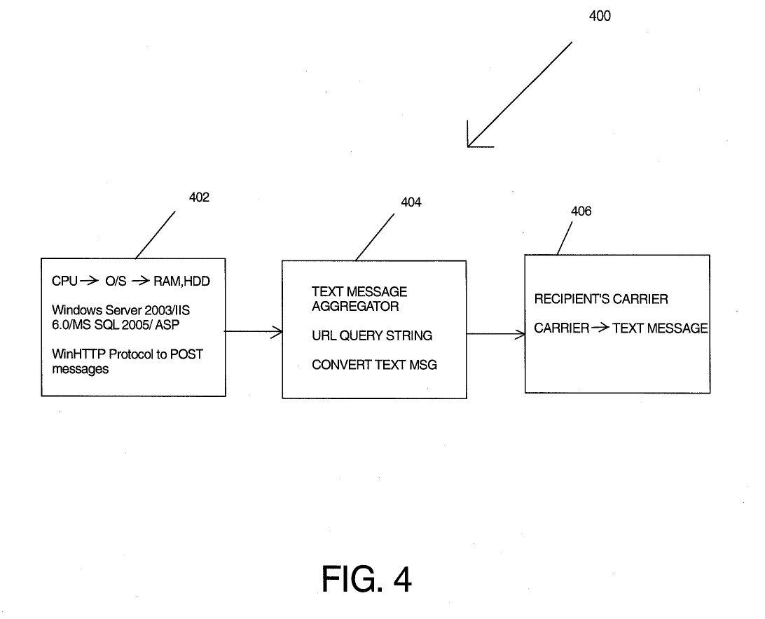

One embodiment of the invention is provided in FIGS. 4, 5, 6A and 6B. Referring to FIG. 4, a flow chart 400 for a sent text message is provided. A user, either the owner or the finder as an example, uses a CPU/Operating System in the in illustrated example, a Windows based storage arrangement to post a message on a computer system 402. The text message is aggregated 404 wherein a URL query string is converted to a text message. This information is set to a recipients carrier 406.

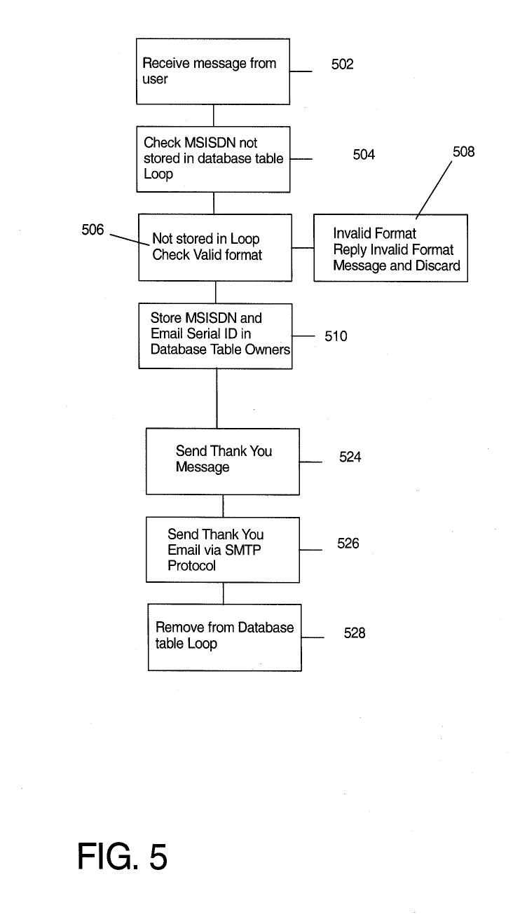

Referring to FIG. 5, an activation process is provided. In this process a message is received from a user, in this case an owner 502 the message containing a serial number and an email address. The message is checked to see if the Mobile Station International Subscriber Director Number (MSISDN) is stored in a database table 504. If the information is not stored, then the message is checked for format validity 506. If the format is not valid, a return message is sent to the owner that the format of the message is not valid and the original message is discarded 508. If the format is valid, then the MSISDN and Serial ID are stored in a database table 510, named Owners. A thank you message 524 may then be sent to the owner through text message and through email via SMTP protocol 526. Lastly, in step 528, the method provides for removal from the database table loop 528.

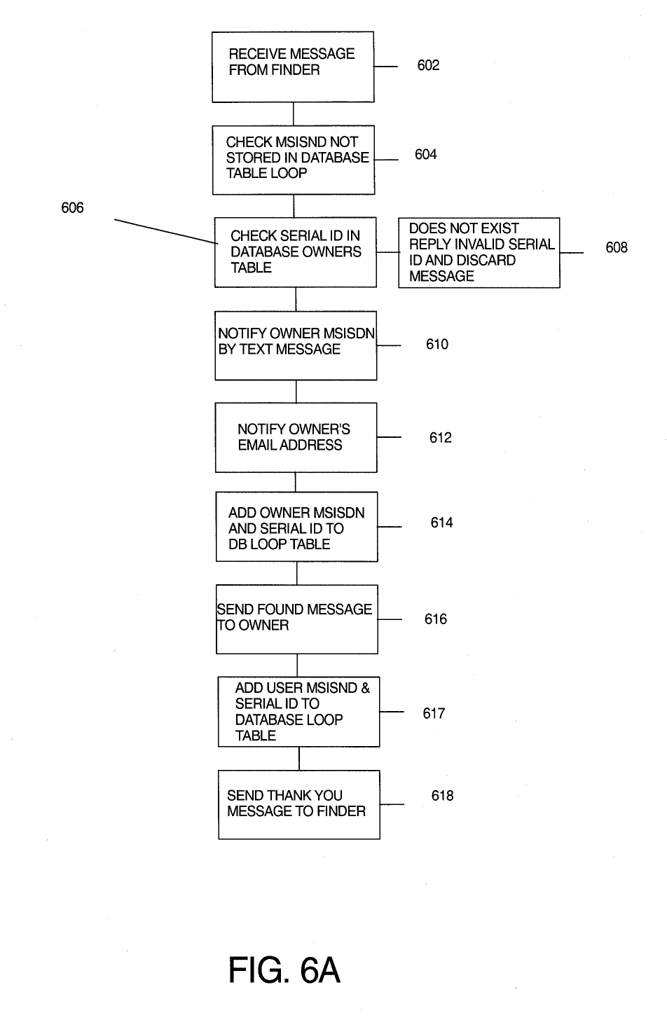

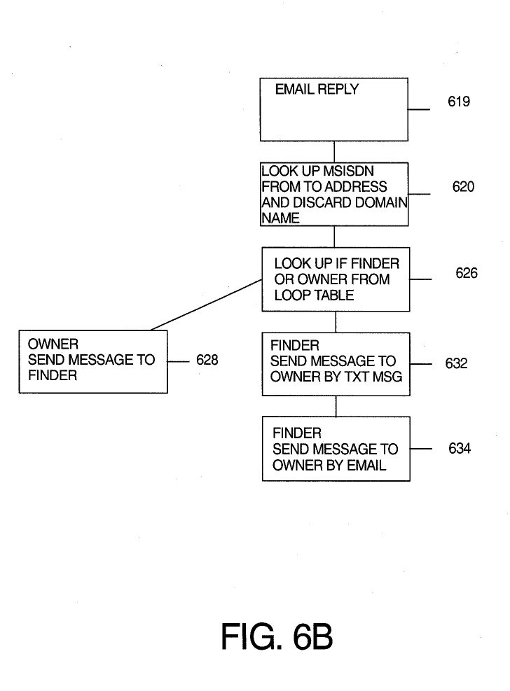

Referring to FIGS. 6A and 6B methods relating to message receipt from a finder, FIG. 6A and email reply, FIG. 6B are provided. In FIG. 6A a message is received from a finder 602 by the system. The MSISDN is checked to see if the information from the message received is stored in the database table loop 604. The serial identification is then checked in a owners database table 606. If the entry does not exist in the owners database table, a reply is sent back that there is an invalid serial identification and the original message is discarded 608. If the check is passed in step 606, then the owner is notified by text message in step 610. The owner is also notified by email in step 612. The owners MSISDN and Serial ID are added to the DB Loop table. In step 617, the user MSISDN and serial ID are added to the database Loop table. In step 618, a thank you message is generated. Referring to FIG. 6B, a method relating to email reply 619 is provided. Once an email reply is received, the email reply MSISDN is looked up as well as the “from” and “to” addresses, The domain name is discarded 620. If the person is an owner, the message is sent to the finder in 628 and an increment count is created 630. If the person is a finder, then the message is sent to the owner via text message 632 and also may be sent by email 634. In some embodiments, all information is received and distributed from a single focal point based upon identified target addresses. The system may use caller identification, as a non-limiting embodiment, as a way to track information received from individuals.

In some embodiments, the replies to text messages may be directed to email account, thereby allowing an owner that is in a cellular network that does not fully cover a geographic region, to receive messages on a computer, obviating the necessity of a cell phone and is particularly useful in the case of a lost cell phone.

Automation of the invention through a computer system allows implementation without the use a concierge service or any other middleman, thereby limiting the costs and problems associated with such services. The present invention provides a method and system to quickly facilitate a text message conversation between individuals, a finder and an owner, whereby the owner's identity remains anonymous. Such conversations allow for quick and accurate communication between individuals, wherein the owner's identity remains anonymous as well as bridging potential conversational divides between individuals.

The systems and methods according to the present invention may be implemented using communication via SMS (short message service) text messages routed through an automatically actuating clearinghouse that can provide a variety of functions including a core function of receiving a finder's message that is routed to the appropriate responsible party so that the finder and responsible party can exchange messages with the finder via the clearinghouse while preserving the anonymity of the owner. E-mail messaging may also be supported as a supplementary communication pathway. The article is prepared for retrieval according to the short code or target address as non-limiting embodiments for the finder's message (such as an SMS) and a serial code or other marking that indicates the particular individual entity found. Although described as using SMS text messages, other types of text messaging may be used, and the described embodiments are merely non-limiting embodiments.

A primary point of access to the system may be via the mobile phone. Embodiments provided allow for immediate access to the finder. The system is more convenient to use than conventional systems since people have a tendency to use cellular telephones frequently.

In some embodiments, the present invention provides an automated message clearinghouse for bridging the text messaging communication between a finder of a lost item and an owner of the lost item in which the owner has the discretion of if and when the finder may learn of the owner's identity. Accordingly, the automated message clearinghouse, upon receipt of a first text message that contains a serial number (which may be a numeric, alphabetic or alphanumeric code), may, pursuant to instructions contained in a computer product that is accessed by the central processing unit of the automated message clearinghouse, access a database to locate the identity of the owner with whom the serial number is associated. The database may contain the identity of a plurality of owners and for each owner there may be one or more serial numbers associated with that owner.

After retrieval of the owner's identity, the clearinghouse will send a text message to the owner that indicates that a lost item has been found. The system may be set up such that this text message identifies the specific item or only that an item of the owner's has been found. This forwarding may occur automatically, i.e., without human intervention. During this forwarding step, the identity of the finder remains associated with the first text message, and when the owner receives the message, the identity of the finder may appear in the from or sender line. Alternatively, in order to avoid rejection by spam filters or to give the owner comfort that the message is not from an unknown source seeking to transmit a computer virus, the from or sender line may be an identification of the clearinghouse, and in the text of the message, which may be referred to as a second message, the identity of the finder may be provided.

The owner may then respond to the text message that has been forwarded to it (the second text message), with what may be referred to as the third text message. The owner, who now has the sender information, has the option of sending the third text message directly to the sender or back through the clearinghouse. If the owner sends the message back through the clearinghouse, the third text message may then be forwarded back to the finder as a fourth text message. When the clearinghouse receives the third text message from the owner, the owner's identity will appear in the sender line. However, before the clearinghouse forwards the message to the finder, the clearinghouse replaces the owner's identifying information with a code. That code may for example be the same text address to which the finder sent the first text message. The owner may elect to have any number of conversations proceed through the clearinghouse, and to have its identity hidden throughout. Thus, in some embodiments, the finder will not have the ability to contact the owner directly until the owner provides sufficient information for the finder to do so.

Throughout this embodiment, the clearinghouse may act upon the instructions contained in the computer program product. Thus, the actions at the clearinghouse maybe automatic responses to the input received from the owner and finder, and it is not necessary to have a human review the text messages at the clearinghouse. Because no human needs to review the messages at the clearinghouse, the methods implemented by this system are rapid, and the time from which the finder reports that she has found the missing items to the time in which the owner receives the second text message can be a matter of seconds, for example, less than 15 seconds, less than 10 seconds, less than 5 seconds, or less than 2 seconds. Similarly, the time from which the owner receives the finder's message and the finder receives the owner's response can be a matter of seconds, for example, less than 15 seconds, less than 10 seconds, less than 5 seconds, or less than 2 seconds.

From the automated clearinghouse's perspective, certain embodiments offer an economy of scale. Because no person at the clearinghouse needs to review the text messages, it can rapidly look up identifying information contained in its databases and forward messages from the finder to the owner and from the owner to the sender while masking the owner's identity. It can also do this for a plurality of owners and finders simultaneously or within very short time spans.

In some embodiments, the computer program products and the instructions executable by a machine may be contained in modules. The modules may exist in computer readable form and be stored on hardware and/or software. The modules are preferably operably coupled directly or indirectly to one another such that when activated or accessed they permit each module to accomplish its desired function and to communicate with all other modules with which communication is desired.

For example, in some embodiments, there may be one or more if not all of the following modules: (a) an owner identification input module that permits the input of the owner's contact information and the serial numbers, which may be a numeric, alphabetic or alphanumeric code, that are to be associated with the products; (b) a storage module that stores the owner's identification information and cross-references it to the serial numbers; (c) a finder text message receiving module for receiving a first text message from a finder of a lost item; (d) a verification module for analyzing the content of the first text message and checking the storage module to determine who the owner is that is associated with the information contained in the first text message; (e) a notification module that is capable of generating a text message to the owner that indicates that a lost item has been found and that identifies the finder by one or more of name, cell-phone number or email address; (f) an owner text message receiving module that is capable of receiving a text message from an owner; (g) an owner identity masking module that is capable of removing owner identification information from the text message from the owner; and (h) a text forwarding module that is capable of forwarding the text message from the owner to the finder without the owner's identifying information.

In the foregoing specification, the aspects of the invention have been described with reference to specific embodiments thereof. It will, however, be evident that various modifications and changes may be made thereunto without departing from the broader spirit and scope of the invention as set forth in the appended Claims. Further, unless otherwise specified or apparent from the context, any feature described being used in connection with one embodiment may be used in connection with any other embodiment. The specification and drawings are accordingly to be regarded in an illustrative rather than in a restrictive sense.

What is claimed is:

1. A method for facilitating a return of a lost article, comprising:
entering personal information into a storage arrangement confidentially linking a marking to an owner; one of affixing a physical identification tag with the marking or affixing the marking to the article, the marking containing text message information to the storage arrangement;
activating an account in the storage arrangement on a receiving of a text message from the owner;
entering a text message using the text message information of the marking into a communication device linked to a storage arrangement and a wireless network upon a finding of the article by a finder;
receiving the text message information from the finder by the storage arrangement over the wireless network;
one of decoding and cross-referencing the text message from the finder by the storage arrangement and identifying the owner who is associated with the text message information;
generating a found message, on the storage arrangement, based upon the text message;
relaying the found message from the storage arrangement to the owner over the wireless network;
receiving a response message by the owner; and
bridging a text message conversation between the owner and the finder, wherein an owner's identity is anonymous.

2. The method according to claim 1, wherein the bridging comprises executing a computer algorithm that masks an owners identify and forwards the response message to the finder.

3. The method according to claim 1, wherein the text message to the storage arrangement is a serial number.

4. The method according to claim 3, wherein the storage arrangement decodes the code in the text message.

5. The method according to claim 1, wherein the article is at least one of a set of keys, a computer, an electronic device, clothing, sun glasses, golf clubs, pets, credit card, personal property and luggage.

6. The method according to claim 5, wherein the electronic device is at least one of a personal digital assistant, a digital music player, a computer and a cellular telephone.

7. The method according to claim 3, wherein the text message is an alpha-numeric code.

8. An arrangement for returning a lost article, comprising:
at least one of a physical identification tag and a marking, wherein the at least one tag and marking has a serial number and a text message address; and
a confidential computer storage arrangement, the computer storage arrangement loaded with owner information operably coupled to at least one owner cellular telephone and the text message address and wherein the confidential computer storage arrangement is configured to receive a cellular telephone text messages at the message address specified in the marking.

9. The method of claim 1, further comprising entering personal information for a plurality of articles wherein each article has a unique marking.

10. The method according to claim 1, wherein the text message is a short message service (SMS) text message.

11. The method according to claim 1, wherein an amount of time between entering the text message into the communication device linked to the storage arrangement and the wireless network upon the finding of the article by the finder and receiving the found message through the wireless network by the owner is less than 30 seconds.

12. The method according to claim 1, further comprising: causing the found message to be displayed on a screen of an electronic device.

13. The method according to claim 1, wherein each owner has a unique text address.

14. The method according to claim 13, wherein during the bridging, a text message is displayed on a screen of an electronic device.

15. A program storage device configured to perform a method to facilitate a conversation regarding a lost article, comprising:
(a) an owner identification input module that permits an input of an owner's contact information and serial numbers;
(b) a storage module that stores the owner's contact information and cross-references the information to the serial numbers;
(c) a finder text message receiving module for receiving a first text message from a finder of a lost item;
(d) a verification module for analyzing content of the first text message and checking the storage module to determine who the owner is that is associated with the information contained in the first text message;
(e) a notification module that is capable of generating a text message to the owner that indicates that a lost item has been found and that identifies the finder by one or more of name, cell-phone number or email address;
(f) an owner text message receiving module that is capable of receiving a text message from an owner;
(g) an owner identity masking module that is capable of removing the owner identification information from the text message from the owner; and
(h) a text forwarding module that is capable of forwarding the text message from the owner to the finder without the owner's identifying information.

16. The method according to claim 1, further comprising:
using caller identification to identify the finder of the article.

17. The method according to claim 1, wherein the text message information contains a serial number.
